(19) United States
(12) Patent Application Publication
(10) Pub. No.: US 2004/0081033 A1
(43) Pub. Date: Apr. 29, 2004

(54) Multiple layer optical storage device

(76) Inventors: Yoel Arieli, Jerusalem (IL); Shay Wolfling, Tel Aviv (IL)

Correspondence Address: DARBY & DARBY P.C., P. O. BOX 5257, NEW YORK, NY, 10150-5257, US

(21) Appl. No.: 10/467,405

(22) PCT Filed: Feb. 5, 2002
(86) PCT No.: PCT/IL02/00096

(51) Int. Cl. G11B 11/00

(52) U.S. Cl. 369/18

(57) ABSTRACT

A multi-layer optical information storage system comprising several layers of generally flat waveguide, arranged one on top of the other in a stack. The reading energy is projected through the layers perpendicularly, and is focussed onto the layer to be read. A detector disposed at the side of the layers detects the energy scattered or reflected from information or data points within the layer. The points within the layers may be in the form of defects of a type that can carry the information assigned to each point, generally by means of the presence or absence of the defect. The energy scattered or reflected from the defects in any specific layer is preferably contained within that layer because of waveguiding properties imparted to the layers by means of a graded or stepped index structure.

### FIELD OF THE INVENTION

The present invention relates to the field of optical information storage devices, especially those based on multi-layered optical disc assemblies.

### BACKGROUND OF THE INVENTION

There exist a number of methods for reading optical information or data stored in multi-layered optical storage devices. A major problem to be overcome with such devices is that during the reading process, each layer interferes optically with the other layers. In most of these prior art methods, the reading beam must be focused on each layer, and the returning energy is read through all the other layers. Every layer should ideally reflect the reading beam focused onto it, and should be transparent to beams intended to read any other layer beneath it. This multi-layered scheme can be performed in many ways, including the methods of focusing coherent light at different levels; using multiple wavelengths, where each layer reflects or transmits a certain wavelength; and using a different fluorescent material in each layer, such that the information from each layer is detected by wavelength discrimination.

The above-mentioned prior art methods have the disadvantage that the number of useable layers is quite limited, since each layer, to some extent, absorbs or interferes with energy going to or coming from the layers beneath it or above it, depending on the optical reading geometry. There therefore exists an important need for a method and apparatus for optically storing information or data in multi-layered optical media, with a higher number of layers than currently useable media, and in such a way that the full density of information on all of the layers of the apparatus can be optically accessed in a manner that is effectively more error free than using the currently available media with that number of layers.

### SUMMARY OF THE INVENTION

The present invention seeks to provide a new multiple layered optical storage device and method, which allow an increase in the number of useable layers, and hence in the stored information density together with faster retrieval of that information when compared with prior art methods and devices.

There is thus provided in accordance with a preferred embodiment of the present invention, an optical information storage medium comprising at least one layer of flat optical waveguide, and more preferably, several layers of flat optical waveguide, arranged one on top of the other in a stack. The reading energy is preferably projected through all of the layers, essentially perpendicularly to the layers, and is focussed onto the layer to be read. One or more detectors disposed at the side of the medium detect the energy scattered or reflected from information or data points within the layers. These data points are operative to perturb the incoming reading energy from its intended path, and are generally described in this application as perturbing centers, and are also so claimed. Such perturbing centers are preferably scattering centers or reflecting centers, and are preferably in the form of defects or imperfections of a type such that they can carry the information assigned to each point, generally by means of the presence or absence of the defect. The energy scattered or reflected by the perturbing centers in any specific layer, is preferably contained within that layer by means of waveguiding properties given to the layers. The waveguide is preferably constructed either with a graded refractive index structure or a stepped index structure to each layer, or by means of layers of reflective material at the layer surfaces to internally reflect the energy within each layer. Furthermore, according to other preferred embodiments of the present invention, the layers may be divided into separate radial tracks, each track being delineated from its neighbor by means of radial waveguiding, which confines the light generated within a track to that track.

The methods of the present invention enable the construction of a storage device with the possibility of having more layers than existing optical storage media, and the retrieval of information from those layers can be performed at high speed.

According to further preferred embodiments of the present invention, the reading energy is input to the layers from a direction parallel to the layers, and read from a direction perpendicular to the layers by using a confocal system. This embodiment is thus similar to the previous embodiment but operates in the reverse direction.

According to yet another preferred embodiment of the present invention, a reading energy beam is input to the layers from a direction parallel to the layers, and a second reading energy beam is focussed onto the layers from the direction perpendicular to the layers. The interaction of both beams is operative to provide an output, by means of a two-photon reading process, and this output is trapped in the waveguide structure of the layer, and is read by a detector at the periphery.

According to yet another preferred embodiment of the present invention, in any of the embodiments where the output light is waveguided to the periphery of the layer for detection, a diffractive optical element or a holographic optical element can be located in the waveguide wall, in order to output the light through the wall of the waveguide and up out of the stack of layers.

According to yet another preferred embodiment of the present invention, the data storage points or defects in the layers can be such as to absorb some or all of the energy focused on to them. The data may be read preferably by positioning a detector at the bottom of the layers, opposite the position of the incident light source. The energy incident on the detector depends on whether there is an impurity in the optical path of the beam, in the layer onto which the beam is focussed for that reading operation, and in the percentage of energy absorbed by that impurity.

According to the various preferred embodiments of the present invention, the reading energy is preferably electromagnetic energy of any wavelength or region of wavelengths, such as visible light, X-rays, infra-red or ultra-violet radiation or radio frequency energy. Most preferably, the reading source is of a coherent monochromatic nature, such as a laser.

The above mentioned multi-layered data storage device can be implemented, according to one preferred embodiment of the present invention, in the form of a compact optical disc, similar in format to currently available optical discs, but with the novel writing, storage and reading processes as described in the various embodiments of the present invention. Use of these embodiments may enable a higher information density and faster reading rate to be achieved than conventional optical disc data storage.

According to another preferred embodiment of the present invention, the multi-layered data storage device can be implemented in an artificial 2-dimensional crystal, such as a Bragg crystal, or a photonic band-gap crystal, in which the reading energy is projected into the storage cube, and from the distribution of the scattering image, the information may be retrieved. The locations of the impurities representing the data can be pre-arranged so that the scattering image is pre-determined.

There is further provided in accordance with another preferred embodiment of the present invention, a an optical data storage device comprising a beam of electromagnetic energy for reading data stored in the device, at least one storage layer generally transparent to the electromagnetic energy, and containing the data in the form of perturbing centers, a focussing system for focussing the beam onto the at least one layer, and a detecting system, disposed peripherally to the at least one layer, and operative to detect energy diverging from at least one of the perturbing centers. The at least one layer may preferably be a stack of layers, in which case the focussing system is preferably operative to focus the beam onto at least one layer of the stack of layers. Furthermore, the detecting system may comprise a single detector disposed peripherally to the stack, or more than one detector disposed peripherally to at least one layer of the stack of layers.

Additionally, in the above-mentioned optical data storage device, at least one layer preferably comprises an optical waveguide operative to contain the diverging energy. The waveguide can preferably comprise either a graded index structure or a stepped index structure. Furthermore, the waveguide may comprise a layer of core material in which the diverging energy propagates, and a cladding layer on both faces of the layer, wherein the refractive index of the core material is higher than that of the cladding material.

In accordance with yet another preferred embodiment of the present invention, the waveguide may comprise a layer of reflective material on the surfaces of the at least one layer. Alternatively and preferably, the waveguide may comprise either a layer of dichroic material on a surface of the at least one layer of the stack, operative so as to contain only the diverging energy of a predetermined wavelength range, or a layer of polarization sensitive material on a surface of the at least one layer of the stack, operative so as to contain only the diverging energy of a predetermined polarization.

In any of the above mentioned preferred embodiments of the present invention, the at least one storage layer or the stack of layers may also comprise an axis perpendicular to the plane of the layer or layers for rotating them.

In accordance with other preferred embodiments of the present invention, in the above-described optical data storage device, the at least one storage layer may be either a static Bragg crystal or a static photonic band-gap crystal.

Furthermore, in any of the preferred embodiments of the above-described optical data storage devices, whether rotating or static, the electromagnetic energy may be visible light, infra-red, ultra-violet radiation, X-radiation or radio frequency energy. Alternatively, it may be a laser beam.

In accordance with still more preferred embodiments of the present invention, the detecting system may comprise a single detector, or a single detector for each layer.

Additionally, the perturbing centers may be scattering centers, reflecting centers, polarization changing centers, or fluorescing centers. They may also be imperfections or defect or doped areas of the at least one layer. The data stored may preferably be represented by the presence or the absence of a perturbing center at a storage location. Additionally, the perturbing centers may have a range of levels of a physical property for perturbing the energy, wherein the data stored is represented by the level of the physical property of a perturbing center at a storage location.

Furthermore, the perturbing center may preferably be operative to effect a change in at least one property of the at least one layer, such as refractive index, the structure, a reflectance, absorbance, a wavelength dependence, birefringence, or the polarization generating properties. The perturbing centers may also preferably be micro-mirrors for reflecting the energy or points which emit fluorescence under the influence of the focussed energy.

In accordance with further preferred embodiments of the present invention, the at least one storage layer may comprise a filter at its periphery, such that it outputs a preselected range of wavelengths. The at least one storage layer may comprise a chalcogenide material, or a photo-refractive material.

There is provided in accordance with yet a further preferred embodiment of the present invention, an optical data storage device as described above and wherein the at least one layer is divided into angularly separate radial tracks, such that the diverging energy generated in one track cannot pass into another track. Such an optical data storage device may also preferably comprise a plurality of pairs of reading beams and peripheral detectors, mutually disposed such that each of the pairs is operative to read information without interference from another of the pairs.

Furthermore, in the above-described optical data storage devices, the data may be written by imprinting the perturbing centers in predetermined storage locations in the at least one layer of the stack during manufacture, or alternatively and preferably, the at least one layer of the stack is manufactured free of the perturbing centers, and the data is written by focussing energy to generate a perturbing center at a predetermined storage location, or the perturbing center may preferably be permanently disposed at the storage location.

Furthermore, the at least one layer of the stack may comprise a photosensitive material in which are generated perturbing centers which may be removed by a predetermined post-treatment, such that the data can be erased. This photosensitive material may preferably comprise a photorefractive material in which are generated perturbing centers with refractive indices different from that of the layer, and the photorefractive material may be such that the refractive index of the perturbing center returns to its normal value when treated with heat.

There is even further provided in accordance with more preferred embodiments of the present invention, an optical data storage device as described above, and also comprising at least one detector disposed on the same side of the at least one layer as the focussing system, such that energy reflected from the at least one layer is detected.

In accordance with more preferred embodiments of the present invention, in the optical data storage device as described above, the energy may be multi-spectral, and the device also comprises separate wavelength filters disposed in the path between the layers of the stack and the detecting system, each wavelength filter being associated with one of the layers, such that the detecting system can read more than one layer simultaneously. In such embodiments, at least one of the wavelength filters may be disposed either on the periphery of its associated layer, or on a detector of the detecting system associated with a predefined layer of the stack.

There is also provided in accordance with a further preferred embodiment of the present invention, an optical disc storage device comprising a stack of transparent storage layers in which data in the form of scattering centers is written, a diode laser disposed opposite one end of the stack, for projecting a reading beam into the layers, a focussing system for focussing the beam onto at least one of the layers, a drive mechanism for rotating the stack around an axis perpendicular to the plane of the layers, and a detecting system, disposed peripherally to the stack, and operative to detect light scattered from at least one of the scattering centers. The optical disc storage device may also comprise a mechanism for scanning the reading beam radially across the stack, and furthermore, the stack of transparent storage layers may preferably be an optical disc having optically separated layers through its thickness. In such a disc, at least one of the optically separated layers may be a waveguiding layer.

In accordance with yet another preferred embodiment of the present invention, there is provided an optical data storage device comprising a beam of electromagnetic energy for reading data stored in the device, and disposed peripherally to the device, at least one storage layer generally transparent to the electromagnetic energy, and containing the data in the form of perturbing centers, a detecting system, disposed perpendicularly to the plane of the at least one layer, and a system for collecting energy diverging from at least one of the perturbing centers into the detecting system. In such a device, the at least one layer may preferably be a stack of layers, and the system for collecting energy may then be a confocal system operative to focus energy from at least one layer of the stack of layers.

There is further provided in accordance with yet another preferred embodiment of the present invention, an optical data storage device comprising a beam of electromagnetic energy for reading data stored in the device, at least one storage layer generally transparent to the electromagnetic energy, and containing the data in the form of perturbing centers, a focussing system for focussing the beam onto the at least one layer, and a detecting system, disposed perpendicularly to the plane of the at least one layer and on a side opposite to the focussing system, for detecting energy diverging from at least one of the perturbing centers. In this device, the at least one layer may preferably be a stack of layers, and the focussing system may then be operative to focus the beam onto at least one layer of the stack of layers.

### BRIEF DESCRIPTION OF THE DRAWINGS

The present invention will be understood and appreciated more fully from the following detailed description, taken in conjunction with the drawings in which:

FIG. 1 shows a general schematic plan view of a multi-layered optical storage device according to preferred embodiments of the present invention, showing the storage medium and reading system;

FIG. 2 is a schematic illustration from the side of a multi-layered optical storage device according to a preferred embodiment of the present invention, showing the multi-layered medium and the reading system;

FIG. 3 is a schematic illustration of a single layer of the storage medium of the present invention, in which the layer is subdivided into separate waveguide tracks;

FIG. 4 is a schematic view of several waveguide layers, each containing information-bearing defects, showing the way in which the information in the desired layer is read without interference from information in other layers;

FIG. 5 is a schematic illustration viewed from the side of a multi-layered optical storage device according to another preferred embodiment of the present invention, in which the optical direction of operation is generally the reverse of that described in the previous embodiments of FIGS. 1 to 4; and

FIG. 6 is a schematic illustration of another multi-layered optical storage device, constructed and operative according to another preferred embodiment of the present invention, in which the data may be read preferably by positioning a detector at the bottom of the layers, opposite the position of the incident light source at the top of the layers.

### DETAILED DESCRIPTION OF PREFERRED EMBODIMENTS

Reference is now made to FIG. 1, which schematically illustrates a general plan view of a multi-layered optical storage device 10, constructed and operative according to a preferred embodiment of the present invention, showing the storage medium and reading system. The device is preferably constructed in the form of a disc 12, such that it is compatible in shape and size with the widely-used compact disc format of data storage. In FIG. 1, because of its plan view form, only one disc-shaped layer is shown, but it is to be understood that the storage device comprises a number of separate disc-shaped layers one on top of the other. The reading laser beam 14 is focussed onto the layer to be read from a direction perpendicular to the layer, and the information-bearing output light 16, after scattering from the defect representing the stored data, is focussed by the lens 18 onto the signal reading detector 20. The lens is generally required to focus the divergent light to provide a sufficient signal level. If the light signal is sufficient, then lens 18 may not be needed. The layer is rotated 22 at high speed, preferably in the conventional manner known in CD technology, to provide beam reading access to all parts of the layer. The position of the data bit to be read is defined by the radial position of the laser reading beam, by the instantaneous angular position of the spinning disc, and by the layer onto which the laser reading beam is focussed. Although in FIG. 1, for reasons of clarity, only one laser reading beam 14 is shown to illustrate the operating principle of the invention, it is to be understood that in practice, a number of beams may preferably be used, each beam located at a different radius on the disc, and all reading simultaneously, such that the whole of the disc area may be read more quickly. Other known details of CD technology may also preferably be used, either in the medium construction, or in the reading mechanism.

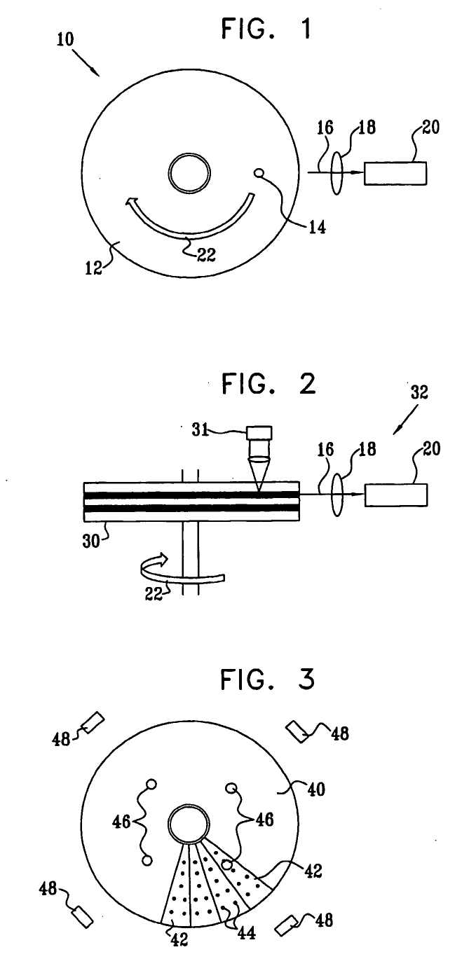

Reference is now made to FIG. 2, which is a schematic illustration viewed from the side of a multi-layered optical storage device according to a preferred embodiment of the present invention. Throughout this application, and as claimed, use of terms such as side, top, bottom and the like, are not meant to limit the invention in any way, but are used in their sense relative to the drawings in order to simplify the explanations of the construction and operation of the various preferred embodiments of the present invention. FIG. 2 shows the incoming beam of energy, shown as preferably coming from a laser diode 31, a multi-layered medium 30 and the reading system 32, comprising the focussing lens 18, and the reading detector 20 of FIG. 1. Each layer acts as a waveguide, containing energy focused in the layer mainly within the layer. One preferred example of this kind of implementation is a waveguide generated on a transparent substrate by means of graded index layers, or stepped index layers. Each layer comprises a thin core layer of transparent material with a higher index of refraction sandwiched between two thin cladding layers of transparent material with a lower index of refraction. Such layers are readily implemented using conventional glass materials having different indices of refraction, as is well known in the art. Such layers can also be readily implemented, by using chalcogenide glasses.

Alternatively and preferably, the waveguiding properties of the layers can be implemented by means of appropriate coatings that limit the propagation of light essentially within the layer or within part of the layer. These coatings may also preferably have specially selected spectral properties, such that they absorb or transmit only a specific part of the electromagnetic spectrum. Thus, for example, if each of the layers are bounded by a dichroic coating, the coating of each layer transmitting a different wavelength of light, then a broadband reading beam could be split into separate wavelength channels, the detector of each layer detecting a separate wavelength range trapped by the dichroic coatings on that layer. Alternatively and preferably, the coatings could be polarization sensitive, and the signals in each layer differentiated by their polarizations.

Reference is now made to FIG. 3, which schematically illustrates how the information storage layer 40 may be further radially divided into separate tracks 42, that enable propagation of a beam only within a given track. The information in each track is contained within the defects 44 within that track. These tracks can preferably be optical fibers. Alternatively and preferably, these tracks can be delineated from each other by means of radial waveguiding, which confines the light generated within a track to that track. According to this preferred embodiment, the energy perturbed by a specific defect, instead of spreading out over the whole of the layer, is confined to the track in which the defect is located. Such an embodiment has two advantages. Firstly, since the light scattered by any defect is not spread over 360°, but is contained within one narrow sector, the signal output from the detector is accordingly higher. An even more important functional advantage can be achieved by locating several reading beams 46 at different angular locations around the stack of layers, and locating several detectors 48 around the periphery of the layers at angularly equivalent positions to the reading beams. With this arrangement, each of the separate pairs of reading beams and detectors can function simultaneously, without the light detected by one detector interfering with the light detected by another detector, since the two signals originate in different tracks, and are contained in different tracks. By this means, the reading speed of the storage device can be increased according to the number of beam/detector pairs incorporated.

According to these preferred embodiments of the present invention, the information in each layer is stored quite independently of the information in other layers. At each predefined physical storage position within each layer, the stored information is represented by either a change, or the lack of a change of one or more properties of the storage medium at that point. According to more preferred embodiments, the change in the property value can be to one of several possible values, where each value represents a different information bit. Furthermore, the change can be a physical change or another change, on condition that the change involves some sort of change in the optical interaction of the material with a light beam at that point.

There are a number of physical, chemical and other properties, the change in which can be used to represent the stored information. Information can be stored by the presence or absence of several kinds of induced ‘defects’ in the material. Such defects may include changes in the refraction index, in the structure, in the reflectance or the absorbance at certain wavelengths, in the birefringence, or in the type of the material, such as its doping or its chemically reactive state. The information may also be stored by ‘doping’ of the original material of the layer with another material, to change its optical properties, such as with finely divided metals, air or gas bubbles, or fluorescent materials. The presence or the lack thereof, and the properties of the doping determine the information stored at a specific position. The defects or doping at each location may preferably be such that the material changes the polarization of the incoming electromagnetic energy, or leaves it unchanged, depending on the information state stored. The storage medium may also be made up of an array of minute mirrors, whose position, configuration, reflectance, or other property determines the information stored.

In addition to the embodiment of the simplest use of any storage property, whereby the presence or absence of a defect defines a single digital zero or one, according to further preferred embodiments, a number of information bits can be stored at a single location, by using several allowed values for each property. These multi-valued properties could preferably be the index of refraction, the reflectance, the absorbance, the physical size, the polarization position, or any other suitable property of the material, or a combination of some of the above mentioned properties. The number of information bits capable of being stored at a single location is equal to log₂ of the number of allowed values of each property. It is also possible to change several physical or other properties in each storage site simultaneously, to increase the total number of information bits and the data rate. The information storage density can be increased even more if the information bits at any position can be read at different wavelengths, such as is described in the PCT application published as International Publication number WO 99/18458 for “A diffractive optical element and a method for producing same” to one of the inventors of the present application, hereby incorporated by reference in its entirety.

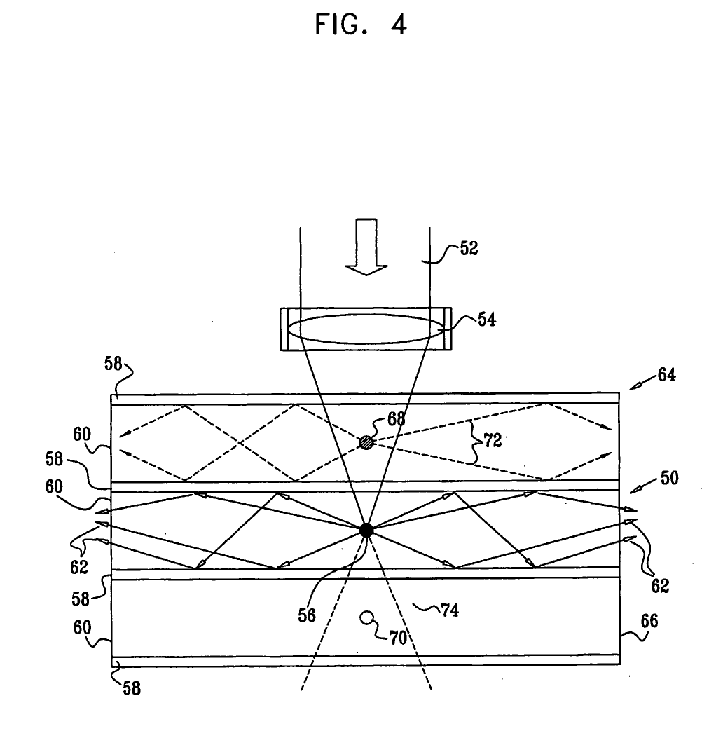

Reference is now made to FIG. 4, which is a schematic view, according to a preferred embodiment of the present invention, of three waveguide layers, each containing information-bearing defects, showing one way in which the information in the desired layer is read without interference from information in the other layers. The term information-bearing or data-bearing used in reference to the defects in this application, and as claimed, is used merely in a descriptive sense, and is not meant to imply that the information or data is necessarily borne by the defects themselves, especially since in many of the embodiments, it is the presence or absence of the defect which represents the data stored in the defect. The reading energy, preferably a laser beam 52, is projected from a direction perpendicular to all the layers, indicated by the top of the drawing of FIG. 4, and is optically focused by means of a lens 54 onto the layer 50 from which the information is desired to be read. The beam is preferably focussed to the center of the layer core. The focused reading energy is scattered in all directions from the data-bearing defect 56 at the desired information storage location. Since the layers have a waveguide structure, with outer cladding layers 58 of lower refractive index than the core material 60, most of the scattered energy is internally reflected and remains within the specific layer in which it is scattered, propagating towards the periphery of the layer 62. The energy is detected, as shown in FIGS. 1 and 2, by means of a reading detector 20, onto which the scattered energy is preferably focussed by a lens 18. The location and the layer that is being read at any given moment is known to the control system of the device. Therefore the time change of the signal at the detector can be translated to read the desired information stored on the media.

In FIG. 4, there are also shown two storage layers 64, 66, on the immediate sides of the layer 50 being read, in order to illustrate how the data reading process is able to address a unique layer without interference from any of the other multiple layers in the storage device. In each of these neighboring layers, data bearing defects are shown respectively located exactly above 68, and exactly below 70, the data bearing defect 56 being read in layer 50. As is observed, the focussing of the reading beam is arranged to be such that at the defect 68 in the top layer 64, the beam diameter at the defect is such that the intensity of the beam at the defect is low. As a consequence, the light 72 scattered by the defect 68 is of very low level, and is scarcely detected by the signal detector, nor does it detract significantly from the intensity of the light falling on the layer 50 being read.

Furthermore, after being scattered by the defect 56 in the layer 50 being currently read, not only is the laser beam divergent, generally at the same angle it was previously convergent, but it also now has a somewhat reduced intensity due to the light scattered out of the beam by the read defect 56, such that the intensity falling on the defect 70 in the lower layer 66 is even lower than that which fell on the defect 68 in the top layer 64. Consequently, very little scattered light from layer 66 is detected by the read detector.

The extent to which the reading process in one layer is immune to cross-talk from other layers is a function of the numerical aperture (NA) of the focussing optical system. A large numerical aperture enables high spatial resolution to be obtained, and a small depth of focus. The focussing lens in the embodiment shown in FIG. 4, is shown having a low F-number (large NA), such that the depth of focus is shown schematically to be substantially less than the inter layer distance. In such a situation, the cross talk between layers is minimized.

The focusing lens 54 is preferably provided with a focussing mechanism, for focussing the beam to any specific layer in order to access the data within that layer. In addition, a mechanism must be provided, which can be optical or mechanical, for moving the lateral location of the focussed beam within the layer. When the present invention is implemented in an optical disc format, any one or more of the laser source, its scanning mechanism, its optical system, and the mechanism responsible for spinning the discs can preferably be similar or identical to the equivalent components used currently in optical storage readers.

According to one preferred embodiment of the present invention, a separate reading detector is provided for each layer of the stack. Alternatively and preferably, the system can be constructed with one detector only, which detects energy from all the layers simultaneously. Identification of the layer from which the signal is detected at any specific point in time is achieved by temporally relating the signal detected, to the specific layer to which the energy is being focused at that time. The use of a single detector means that there is no need to accurately position the detector in relation to the position of the information layers, as is necessary with the one-detector-per-layer embodiment. In order to increase the signal, the detector can be arranged to collect the light emitted from longer segments of the perimeter sides of the layers.

According to yet another preferred embodiment of the present invention, fluorescent material can be incorporated into each storage layer, the fluorescent material being such as to fluoresce only under exciting illumination above a certain threshold level. The material is chosen such that only around the focus is this threshold level achieved. Consequently, the incident reading energy beam generates a fluorescent interaction only at the specific layer onto which it is focussed, and its intensity is too low to generate interaction in other layers which are ‘out-of focus’. The energy emitted from the fluorescent material propagates mainly within the layer, due to its waveguide properties, and is collected by the optical reading detector system at the perimeter of the waveguide.

Schemes in which several layers of information are read simultaneously can be used to effectively increase the reading rate. According to one such preferred embodiment of the present invention, several layers of information can be read simultaneously by using a multi-spectral reading energy source, and focusing each wavelength onto a different layer. In this embodiment, the system may contain several detectors, each one detecting signals from a specific layer or from several possible layers. The detectors can preferably be positioned at the same or at different locations along the media perimeter. The detectors can include spectral filters to differentiate the information from each layer more effectively. Differentiation between different layers can also be performed with a single detector, by using the spectral properties of the detected signal. This can preferably be performed by means of filters disposed around the perimeters of each layer, the filters having different passbands.

Several layers of information can also be read simultaneously by using a monochromatic reading energy source which is split into several beams or into several different focussed points. This may preferably be achieved by various means known in the art, such as gratings, diffractive optical elements, beam splitters or by means of several reading heads. The signals from the different simultaneously read layers can be either read on different detectors, or can be directed to a single ‘long’ detector, such as a CCD array for analyzing the spatial pattern. According to another preferred embodiment, each layer perimeter may be coated with a polarized material, and the signals read at different polarizations.

The information can be written onto the storage medium of the system of the present invention in many different ways, some of them modified from existing processes known in optical storage, for use in the embodiments of the present invention.

According to a first preferred writing method, a ‘write-once’ process can be performed similar to existing optical storage mastering process. A ‘master’ is produced for every layer. The information is imprinted in the first layer by a first master, which is then coated with a low-refraction index material thereby producing the waveguide structure for the first layer. On top of that, a high refraction index material is coated, and a second master is then imprinted, together with its surrounding low index material, and so on for as many layers as are desired. The imprint process may be similar to the existing plastic injection processes known in the prior art, using various transparent materials.

According to a second preferred writing method, there is provided a method whereby the writing is performed onto an empty medium, in which all of the waveguide layers are free of information-bearing defects or doping. The defects can be introduced by one of several methods, such as by the use of focused energy either to generate defects in the material at the required position at each layer, or to generate a localized micro-chemical reaction which leaves a data-bearing product. According to other preferred embodiments of this method, it is possible to inject impurities of different materials, including gases, into the empty medium.

According to a third preferred writing embodiment of the present invention, there is provided a rewriteable or erasable multi-layer optical storage device which utilizes transparent photosensitive materials that change their refraction index when electromagnetic energy, such as a laser at a given wavelength, is focused onto them. Such materials are known as photo-refractive materials. In this embodiment, the change in refraction index is reversible and can be erased by heating the material. Examples for such materials are chalcogenide glasses that also have high refraction indices, and are also appropriate for use as a waveguide core material.

According to another preferred embodiment of the present invention, such a rewriteable medium can alternatively be provided by using magneto-optical defects similar to those used in existing magneto-optical devices, wherein the information is written magnetically, and is read optically according to any of the preferred embodiments of the present invention.

According to more preferred embodiments of the present invention, the above-described methods of reading, such as the use of different types of defects, different sorts of physical changes, the use of multiple wavelengths, and so on, can be advantageously applied also to the writing process for storing the data.

Furthermore, in any of the above-mentioned embodiments for writing, the writing can preferably be achieved by means of a two-photon process, whereby the sensitivity of the medium is such that information is written into a location at the intersection of two laser beams, one preferably from the top of the medium, i.e. perpendicular to the layers, and the other from the side of the medium, i.e. parallel to the layers.

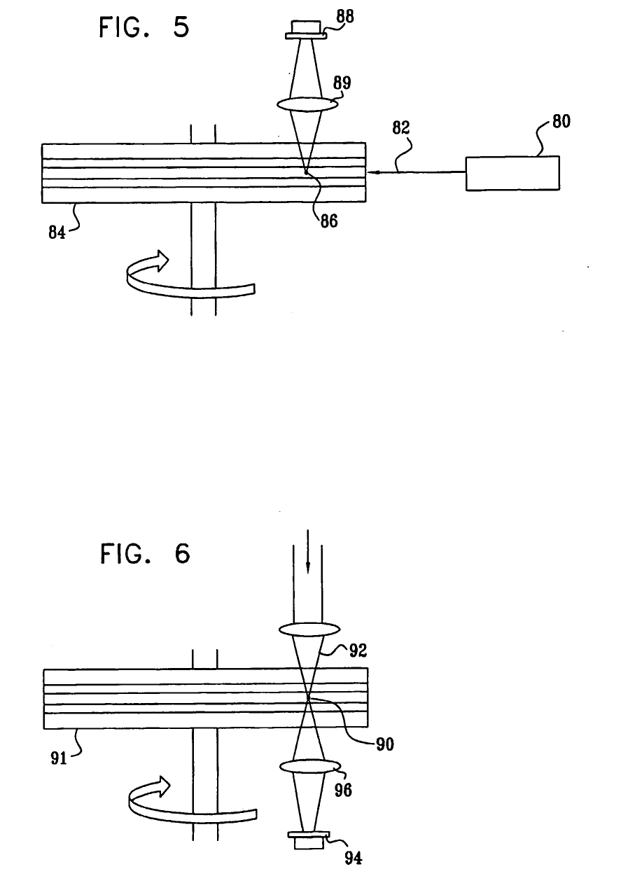

The above-mentioned embodiments of the present invention can be made operative to read existing optical disc storage devices by adding a detector close to the reading energy source. Such a detector could be similar to that shown in FIG. 5 hereinbelow, as item 88. The various embodiments of the present invention can thus be made to be compatible with currently available compact disc formats, such that the system can be a universal system, capable of reading conventional currently available compact discs and also discs constructed and operative according to the present invention.

Reference is now made to FIG. 5, which is a schematic illustration viewed from the side of a multi-layered optical storage device according to another preferred embodiment of the present invention. In the device shown, the optical direction of operation is generally reversed in comparison to that described in the above-mentioned embodiments of FIGS. 1 to 4, in that the reading beam, is input to the layer in a direction approximately parallel to the layers, i.e. from the side, and the reading itself is performed from a direction perpendicular to the plane of the layers, i.e. from the top (or bottom). In the preferred embodiment shown, a reading laser 80 directs its beam 82 into a layer 84, and the scattered light from the information bearing defect 86 is read by the detector 88 by means of a confocal system, represented by the lens 89. It should be emphasized that although FIG. 5 illustrates a simple embodiment of the “reverse direction” device to that shown in FIG. 2, the other preferred embodiments shown in any of FIGS. 1 to 4, and their details of construction or operation, such as the different reading methods, the different information bearing defects, etc., are all applicable also to the embodiment shown in FIG. 5.

Reference is now made to FIG. 6, which is a schematic illustration of another multi-layered optical storage device, constructed and operative according to another preferred embodiment of the present invention. In this embodiment, the data storage points or defects or impurities 90 in the layer to be read 91 are such as to absorb some or all of the energy of the reading beam 92 focused on to them. The data may be read preferably by positioning a detector 94 at the bottom of the layers, opposite the position of the incident light source. The energy incident on the detector depends on whether there is an impurity in the optical path of the beam, in the layer onto which the beam is focussed for that reading operation, and in the percentage of energy absorbed by that impurity. A confocal system 96 is shown collecting the light diverging from the layer, to determine whether or not there is a data-bearing defect at that read position in that layer, though if the illumination level is good, it is possible to position the detector directly in the path of the diverging beam without the need for a confocal lens. Since the light passes through all of the layers, the layer being read at any time is selected from the other layers by focussing the beam thereupon. This embodiment has advantages over the generally used multilayer optical disc which operates by reflection, and in which, any reading beam has to pass through layers twice, once in its incident path to read the layer, and then on its return path with the information. According to the present invention, with detection on the opposite side of the disc to the reading beam, only one traverse of the disc layers is necessary, thereby reducing optical losses and the likelihood of interference between the information on different layers.

According to further preferred embodiments of the present invention, it is possible to create guided illumination in the form of evanescent waves in the waveguide. If a sufficiently small optical artifact is utilized as the perturbing center in the process of reading from the recording medium, a first order diffracted wave, parallel to the medium surface, results. This diffracted illumination is in the form of an evanescent field. Such non-radiating illumination cannot leave the medium surface. The amplitude of the illumination decreases exponentially with distance from the medium surface. If such small optical artifacts are used in the preferred embodiments of the present invention, however, this illumination can be directed out to the detector by means of the waveguide.

In any of the above-described embodiments of the present invention, and where appropriate, any of the techniques of optical or other technology known in the art may be used to increase the functionality, efficiency or cost effectiveness of the device. Thus, for instance, the optical components of the focusing system or of the reading system can preferably be implemented in planar optics.

Furthermore, any of the optical components can be corrected for chromatic aberration, such as by utilizing diffractive optical elements such as those described in the above-mentioned PCT International Publication No. WO 99/18458. By the use of such techniques, different wavelengths of the reading beam can be directed to different layers of the storage device.

In addition, in order to improve the quality of the optical system or to improve the image processing, or to facilitate the retrieval and analysis of the information, additional optical components, including beam splitters, beam expanders, lenses, diffractive elements, spatial and spectral filters of different kinds can be advantageously added to the optical paths of any of the above mentioned embodiments, as is known in the art.

Furthermore, the signal to noise ratio of the information signal reaching the detector, in any of the above-mentioned preferred embodiments, can be enhanced by a number of techniques, such as by providing the defects with specific shapes that preferentially reflect more of the energy towards the detector, by the use of anti-reflective coatings, by using different wavelengths or different polarizations for different layers or detectors, by the use of more than one beam of reading energy, or by splitting a single beam into several ones, by using signal-processing methods, or by any other of the techniques known in the art.

Furthermore, the different waveguide layers can preferably be constructed to have different spectral filtering properties, different transmittance, different critical angles within the layers, and different polarization directions. Such differences can be advantageously utilized to improve or facilitate the retrieval and analysis of the information.

The optical detecting system at the perimeter of the layers can preferably include a focusing optical system, and can incorporate spectral or spatial filters, or polarizers to enhance the signal detection, all as are known in the art.

The detected signals can be subjected to a variety of signal and image processing algorithms, including noise reduction, image enhancement, correlation, filtering, as is known in the field of signal processing.

In order to quantify some of the parameters which determine the performance of the multiple-layer storage device according to the preferred embodiments of the present invention, some specific numerical values are now given for typical system performance. It is to be emphasized that these numerical examples are for illustrative purposes only, and are not intended to limit the invention in any way.

Firstly, calculation is made of the power level of the light that reaches the detector, after scattered by a defect in a planar waveguide.

Assuming that the fraction of the laser power scattered by the defect is P, the power of light H reaching the detector is:

$$H = \frac{E \cdot P \cdot L}{2 π R} ( 1 - {sin}^{2} {θ}_{c} )$$

where:

E—the incident laser power;

R—the lateral distance between the defect and the detector;

L—the perimetral length of the detector; and

θ_{c}—the critical angle between the core and cladding of the waveguide.

The critical angle is given by

$$sin {θ}_{c} = \frac{{n}_{2}}{{n}_{1}} ,$$

where n₁ and n₂ are the refractive indices of the core and the cladding respectively.

Assuming P=0.05, n₁=1.6, n₂=1.5, R=6 cm. and L=1 cm, the power of light that reaches the detector is calculated to be 0.3% of the laser power. Using reading lasers with power outputs in the few mW level range, power falling on the detector in the ten μW level range is readily detected with a good signal to noise level.

The limitation of the number of layers which it is possible to incorporate into one disc is now calculated, in order to estimate the disc capacity. The depth of focus of a lens is given by

$$δ F = \frac{λ}{{NA}^{2}} ,$$

where NA is the numerical aperture of the lens.

Assuming that λ=0.5 μ and for a lens with NA=0.7, the depth of focus is 1 μ. This means that it is possible to use layers of thickness of that order, while maintaining a reliable reading process without interference between layers, such that a very large number of layers can be built into a disc having a thickness comparable with existing CD storage devices. In more practical terms, by allowing a distance of 20 times the depth of focus between adjacent layers, a typical storage layer would be made up of a layer of higher refractive index of 1 μ thickness and a 19 μ layer of lower refractive index. Thus, in a CD disc of thickness 2 mm, it would be possible to include 100 such layers of 20 μ thickness each.

The interaction and cross-talk between adjacent disc layers can now be calculated. It is assumed that the lateral dimensions of a single scattering defect is 0.4×0.4 microns and that a defect density of 1 defect/micron-square can be used. In such a case, the filling ratio of a defect in its storage location is 0.16. In the worst case, where all of the storage locations in the adjacent disc layers are occupied with defects, the ratio between the light power scattered by these neighboring layers to the light scattered by the layer where light is focused on, is no more then the filling ratio, which is 0.16. Even in these circumstances a reasonable signal-to-noise ration can be obtained. However, it should be emphasized that this is the worst-case situation, and the average case is represented by having approximately half the storage locations in the adjacent disc layers occupied with defects, such that the average signal-to-noise ratio will be even better.

Calculation is now made of the Fresnel reflection between the different layers due to their difference in the refractive index. Such Fresnel reflections would result in an increase in leakage from one layer to its neighbors, and a consequent reduction in sensitivity and increase in cross-talk. The Fresnel relations for reflections from boundaries of different refractive indices are given by:

$$\begin{matrix}{r}_{‖} = \frac{{n}_{2} cos {θ}_{i} - {n}_{1} cos {θ}_{t}}{{n}_{2} cos {θ}_{i} + {n}_{1} cos {θ}_{t}} \\ {r}_{+} = \frac{{n}_{1} cos {θ}_{i} - {n}_{2} cos {θ}_{t}}{{n}_{1} cos {θ}_{i} + {n}_{2} cos {θ}_{t}}\end{matrix}$$

where r_{∥} and r₊ are respectively the light amplitude reflection coefficients for parallel and perpendicular polarizations, and θ_{I}, θₜ are the incident and refracted ray angles respectively.

The magnitudes of each of the amplitude reflection coefficients decrease with decreasing differences between the refractive indices, and increase with increasing angles of incidence. The intensity reflection coefficients are the square of the amplitude reflection coefficients. Taking a maximum incident angle of 45°, the intensity reflection coefficients can be calculated to be 3.24×10⁻⁶ and 0.0018 for parallel and perpendicular polarization, respectively. Both these fractions are very small.

It should be noted that this is the worst case for the maximum incidence angles of the rays at the edges of the laser beam. The average intensity reflection coefficient over the whole beam is even smaller. It should also be noted that according to the laws of reflection, a ray that is transmitted across one boundary of a parallel slab and reflected from the second boundary, should be transmitted back outside the slab, except for the small effect of secondary reflections.

Furthermore, the rays reflected suffer from multiple reflections and for 2 or 3 reflections, a negligible power reaches the detector (note that the reflections here are for angles smaller then the critical angle).

By calculating the different possible optical paths from a defect to the detector due to different refraction angles, it can be shown that reading rates of up to about 10¹⁰ bits/second can be obtained, before the dispersion becomes significant.

The present invention has been described above in terms of optical storage devices, optical media probably being, after magnetic media, the most commonly used storage media currently available. It is to be understood, however, that the present invention is not meant to be confined to the use of optical or even other electromagnetic energy for the reading process, but is equally applicable with other forms of radiative energy, such as acoustic energy, or ultrasonic energy. The components and layer structures required for such alternative embodiments will be evident to those of skill in the art.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

We claim:

1. An optical data storage device comprising:
a beam of electromagnetic energy for reading data stored in said device;
at least one storage layer generally transparent to said electromagnetic energy, and containing said data in the form of perturbing centers;
a focussing system for focussing said beam onto said at least one layer; and
a detecting system, disposed peripherally to said at least one layer, and operative to detect energy diverging from at least one of said perturbing centers.

2. An optical data storage device according to claim 1 and wherein said at least one layer is a stack of layers, and said focussing system is operative to focus said beam onto at least one layer of said stack of layers.

3. An optical data storage device according to claim 2 and wherein said detecting system comprises a single detector disposed peripherally to said stack.

4. An optical data storage device according to claim 2 and wherein said detecting system comprises at least one detector disposed peripherally to at least one layer of said stack of layers.

5. An optical data storage device according to claim 1, and wherein said at least one layer comprises an optical waveguide operative to contain said diverging energy.

6. An optical data storage device according to any of claims 2 to 4, and wherein at least one layer of said stack comprises an optical waveguide operative to contain said diverging energy.

7. An optical data storage device according to claim 6 and wherein said waveguide comprises a graded index structure.

8. An optical data storage device according to claim 6 and wherein said waveguide comprises a stepped index structure.

9. An optical data storage device according to either of claims 7 and 8, and wherein said waveguide comprises a layer of core material in which said diverging energy propagates, and a cladding layer on both faces of said layer, wherein the refractive index of said core material is higher than that of said cladding material.

10. An optical data storage device according to claim 6 and wherein said waveguide comprises a layer of reflective material on the surfaces of said at least one layer.

11. An optical data storage device according to claim 6 and wherein said waveguide comprises a layer of dichroic material on a surface of said at least one layer of said stack, operative so as to contain only said diverging energy of a predetermined wavelength range.

12. An optical data storage device according to claim 6 and wherein said waveguide comprises a layer of polarization sensitive material on a surface of said at least one layer of said stack, operative so as to contain only said diverging energy of a predetermined polarization.

13. An optical data storage device according to any of claims 1 to 10 and wherein said at least one storage layer also comprises an axis perpendicular to the plane of said at least one layer for rotating said at least one layer.

14. An optical data storage device according to any of claims 1 to 10 and wherein said at least one storage layer is a static Bragg crystal.

15. An optical data storage device according to any of claims 1 to 10 and wherein said at least one storage layer is a static photonic band-gap crystal.

16. An optical data storage device according to any of claims 1 to 14 and wherein said electromagnetic energy is selected from a group consisting of visible light, infra-red, ultra-violet radiation, X-radiation and radio frequency energy.

17. An optical data storage device according to any of claims 1 to 14 and wherein said beam of electromagnetic energy is a laser beam.

18. An optical data storage device according to any of claims 1 to 17 and wherein said detecting system comprises a single detector

19. An optical data storage device according to any of claims 1 to 17 and wherein said detecting system comprises a single detector for each layer.

20. An optical data storage device according to any of claims 1 to 19, and wherein at least one of said perturbing centers is selected from the group consisting of a scattering center, a reflecting center, a polarization changing center, and a fluorescing center.

21. An optical data storage device according to any of claims 1 to 19 and wherein at least one of said perturbing centers is selected from the group consisting of an imperfection and a defect.

22. An optical data storage device according to any of claims 1 to 21 and wherein said data stored is represented by the presence or the absence of a perturbing center at a storage location.

23. An optical data storage device according to any of claims 1 to 21 and wherein said perturbing centers have a range of levels of a physical property for perturbing said energy, and wherein said data stored is represented by the level of said physical property of a perturbing center at a storage location.

24. An optical data storage device according to any of claims 1 to 23 and wherein said perturbing center is operative to effect a change in at least one property of said at least one layer, selected from a group consisting of refractive index, structure, reflectance, absorbance, wavelength dependence, birefringence, and polarization generating properties.

25. An optical data storage device according to any of claims 1 to 24 and wherein said perturbing centers are doped areas of said at least one layer.

26. An optical data storage device according to any of claims 1 to 24 and wherein said perturbing centers are micro-mirrors for reflecting said energy.

27. An optical data storage device according to any of claims 1 to 24 and wherein said perturbing centers are points in said at least one layer which emit fluorescence under the influence of said focussed energy.

28. An optical data storage device according to any of claims 1 to 24 and wherein said at least one storage layer comprises a filter at its periphery, such that it outputs a preselected range of wavelengths.

29. An optical data storage device according to any of claims 1 to 24 and wherein said at least one storage layer comprises a chalcogenide material.

30. An optical data storage device according to any of claims 1 to 24 and wherein said at least one storage layer comprises a photo-refractive material.

31. An optical data storage device according to any of claims 1 to 24 and wherein said at least one layer is divided into angularly separate radial tracks, such that said diverging energy generated in one track cannot pass into another track.

32. An optical data storage device according to claim 31 and also comprising a plurality of pairs of reading beams and peripheral detectors, mutually disposed such that each of said pairs is operative to read information without interference from another of said pairs.

33. An optical data storage device according to claim 6 and wherein said data is written by imprinting said perturbing centers in predetermined storage locations in said at least one layer of said stack during manufacture.

34. An optical data storage device according to claim 6 and wherein said at least one layer of said stack is manufactured free of said perturbing centers, and said data is written by focussing energy to generate a perturbing center at a predetermined storage location.

35. An optical data storage device according to claim 34 and wherein said perturbing center is permanently disposed at said storage location.

36. An optical data storage device according to claim 34 and wherein said at least one layer of said stack comprises a photosensitive material in which are generated perturbing centers which may be removed by a predetermined post-treatment, such that said data can be erased.

37. An optical data storage device according to claim 36 and wherein said at least one layer of said stack comprises a photorefractive material in which are generated perturbing centers with refractive indices different from that of said layer.

38. An optical data storage device according to claim 37 and wherein said photorefractive material is such that said refractive index of said perturbing center returns to its normal value when treated with heat.

39. An optical data storage device according to any of claims 1 to 24 and also comprising at least one detector disposed on the same side of said at least one layer as said focussing system, such that energy reflected from said at least one layer is detected.

40. An optical data storage device according to any of claims 2 to 24 and wherein said energy is multi-spectral, and also comprising separate wavelength filters disposed in the path between said layers of said stack and said detecting system, each wavelength filter being associated with one of said layers, such that said detecting system reads more than one layer simultaneously.

41. An optical data storage device according to claim 40 and wherein at least one of said wavelength filters is disposed on the periphery of its associated layer.

42. An optical data storage device according to claim 40 and wherein at least one of said wavelength filters is disposed on a detector of said detecting system associated with a predefined layer of said stack.

43. An optical disc storage device comprising:
a stack of transparent storage layers in which data in the form of scattering centers is written;
a diode laser disposed opposite one end of said stack, for projecting a reading beam into said layers;
a focussing system for focussing said beam onto at least one of said layers;
a drive mechanism for rotating said stack around an axis perpendicular to the plane of said layers; and
a detecting system, disposed peripherally to said stack, and operative to detect light scattered from at least one of said scattering centers.

44. An optical disc storage device according to claim 43 and also comprising a mechanism for scanning said reading beam radially across said stack.

45. An optical disc storage device according to either of claims 43 and 44, and wherein said stack of transparent storage layers comprises an optical disc having optically separated layers through its thickness.

46. An optical disc storage device according to claim 45 and wherein at least one of said optically separated layers are waveguiding layers.

47. An optical data storage device comprising:
a beam of electromagnetic energy for reading data stored in said device, and disposed peripherally to said device;
at least one storage layer generally transparent to said electromagnetic energy, and containing said data in the form of perturbing centers;
a detecting system, disposed perpendicularly to the plane of said at least one layer; and
a system for collecting energy diverging from at least one of said perturbing centers into said detecting system.

48. An optical data storage device according to claim 47 and wherein said at least one layer is a stack of layers, and said system for collecting energy is a confocal system operative to focus energy from at least one layer of said stack of layers.

49. An optical data storage device comprising:
a beam of electromagnetic energy for reading data stored in said device;
at least one storage layer generally transparent to said electromagnetic energy, and containing said data in the form of perturbing centers;
a focussing system for focussing said beam onto said at least one layer; and
a detecting system, disposed perpendicularly to the plane of said at least one layer and on a side opposite to said focussing system, for detecting energy diverging from at least one of said perturbing centers.

50. An optical data storage device according to claim 49 and wherein said at least one layer is a stack of layers, and said focussing system is operative to focus said beam onto at least one layer of said stack of layers.
